(19) United States
(12) Patent Application Publication
(10) Pub. No.: US 2008/0223172 A1
(43) Pub. Date: Sep. 18, 2008

(54) Hollow Shaft with at Least One Balancing Weight, and Process for Producing It

(76) Inventors: Thomas Pullen, Aachen (DE); Rolf Cremerius, St. Augustin (DE)

Correspondence Address: Dickinson Wright PLLC, 38525 Woodward Avenue, Suite 2000, Bloomfield Hills, MI, 48304, US

(21) Appl. No.: 10/562,804

(22) PCT Filed: Sep. 10, 2004
(86) PCT No.: PCT/EP2004/010119

§ 371 Date: May 19, 2008

(51) Int. Cl. F16F 15/32

(52) U.S. Cl. 74/572.4; 228/33

(57) ABSTRACT

The invention relates to a method for fixing at least one balancing weight (1) to at least one point (2) on a hollow shaft (3), whereby the balancing weight(s) (1) is or are soldered to said point(s) (2). The invention also relates to hollow shafts (3) that have been produced according to said method and to a drive system (13) for a vehicle (14). The method facilitates the production of especially light, heavy-duty drive shafts for motor vehicles.

The invention relates to a process for fixing at least one balancing weight to at least one location on a hollow shaft, and to a corresponding hollow shaft.

Rotationally symmetrical, rotating hollow bodies or hollow shafts of the type discussed here, in particular hollow shafts or housings of hydrodynamic torque converters, such as for example including driveshafts used in the automotive industry, for manufacturing reasons usually have a certain unbalance, which has to be compensated for by locally targeted securing of a weight-balanced balancing mass, generally in the form of a sheet-metal strip.

At least in series production, balancing masses of this type are usually welded on by resistance welding, since these welds can be executed quickly and reliably with little outlay on apparatus. However, this form of welding requires a high design strength of the shaft at the location where the balancing mass is attached, so that the welding electrode can press the balancing mass onto the hollow shaft with the required high force without depressing the cylindrical wall of the hollow shaft itself.

Furthermore, fusion welding processes, such as for example resistance welding, laser welding or TIG welding, produce what are known as “metallurgical notches”. The term “metallurgical notch” is to be understood as meaning a locally relatively sharply defined surface hardening of the base material, which forms on account of the liquidus line being exceeded, with subsequent self-quenching during the welding operation. This local surface hardening, during subsequent use of hollow shafts of this type, is often the cause of component failure, since it is unable to withstand the dynamic stresses.

The thermal influencing of the hollow shaft by the welding processes accordingly leads to a local weakening of the component strength which represents one of the most frequent causes of failure in the service life test of the balanced components. It should also be taken into account that if possible only a small number of balancing masses of this type should be fixed to the hollow shaft, in order to minimize the technical outlay involved in a balancing operation of this nature.

On account of new designs of the hollow shafts as light metal shafts (for example comprising aluminium, magnesium, etc.), moreover, there is a requirement for different materials to be joined. This is only possible with very considerable restrictions using the commercially available welding processes described above. One reason for this, in the context of hollow shafts comprising an aluminium alloy, is for example the oxide layer which is formed.

Furthermore (in the case of plastic hollow shafts) it is known to have been attempted to join the balancing mass by adhesive bonding. Hitherto, however, it has not been possible for this process to be made sufficiently reliable, in particular for series production, that permanent fixing of the balancing mass to the hollow shaft can be ensured. In particular, there is always a risk of the adhesive used failing to permanently fix the balancing masses in particular at high use temperatures and/or high rotational speeds of the hollow shaft. Furthermore, the required setting times are generally relatively long, which means that they do not satisfy the requirements for series production.

Working on this basis, it is an object of the present invention to provide an improved process for fixing at least one balancing weight to at least one location on a hollow shaft. In so doing, the technical problems which have been mentioned in connection with the prior art are to be avoided or at least partially reduced. Furthermore, it is intended to specify a hollow shaft which can be used in particular for use in a drive system of a vehicle.

These objects are achieved by a process for fixing at least one balancing weight to at least one location on a hollow shaft having the features of Patent Claim 1 and a hollow shaft having the features of Patent claim 11. Advantageous configurations of the process and of the hollow shafts are described in the respective dependent patent claims. In this context, it should be noted that the technical features listed individually in the patent claims can be combined with one another in any technologically appropriate way and lead to further embodiments of the invention.

The process according to the invention for fixing at least one balancing weight to at least one location on a hollow shaft is characterized in that the at least one balancing weight is secured to the at least one location by means of soldering. The term “soldering” is to be understood as meaning a joining process which in particular comprises joining metallic materials by means of melting additional substances (solders); the melting point of these solders is below that of the two materials of the parts to be joined (in this case the hollow shaft and the balancing weight). This process is advantageous since it is also simple to integrate in series production and the desired joins can be generated without significantly affecting the properties of the balancing weight and/or of the hollow shaft. In particular, the relatively low working temperatures means that microstructural damage or tempering phenomena are avoided.

In connection with the soldering joining process, a fundamental distinction is drawn between soft soldering and hard soldering (brazing). In the case of soft soldering, the solder melts, for example, at below 4500C, whereas in the case of hard soldering the solder melts in a range from approx. 450° C. to 800° C. The use of these joining processes therefore also means that the hollow shaft is not deformed or is only very slightly deformed. Moreover, no metallurgical notches (locally relatively sharply defined surface hardening) are formed.

On account of the use according to the invention of the soldering process to join the balancing weights to the hollow shaft, in particular the following differences are observed with respect to the known welding processes:
during the soldering, the surface is only briefly wetted at approx. 300° C., whereas welding requires surface fusion above the melting point of the individual components, in the case of steel approx. 1600° C. (for example down to a depth of 0.2 mm up to the entire wall thickness). The lower effective heat on the hollow shaft resulting from soldering means that local surface hardening in the microstructure of the hollow shaft and the risk of the formation of cracks through shrinkage stresses are avoided.
The soldering operation requires only very low positioning forces. Welding requires the application of relatively high compressive forces, which can lead to a mechanical notch.
The soldering allows oxidation-free joining of different materials.
A soldered join can be reversed without destroying the hollow shaft. This for the first time creates fixing of the balancing weights which can be released (again). This is a crucial benefit for example with regard to the ability of hollow shafts of this type to be recycled. Moreover, it is in this way possible to correct balancing and/or assembly errors at low cost.

The location at which the at least one balancing weight is fixed to the hollow shaft is not usually arbitrary. The at least one location can be identified using conventional methods known to the person skilled in the art. In this respect, no more detailed description of this process step is required. Depending on the type of hollow shaft and its structure, it may be necessary for a plurality of balancing weights to be fixed on the surface of a hollow shaft of this type. For example, in the case of what is known as a single-part structure, 2 balancing planes are provided, in which balancing weights are fitted. In the case of a two-part structure (with an intermediate bearing), 3 balancing planes are provided, and in the case of a three-part structure (with two intermediate bearings), 4 balancing planes are provided. The fixing of a plurality of balancing weights may take place individually or at least partially simultaneously. In general, the fixing on different balancing planes takes place at different times, since each individual balancing weight has to be placed in the balancing plane in each case with a determined gradient of 0-360°.

According to a further configuration of the process, the at least one balancing weight is secured by means of soft soldering. The use of the soft soldering joining process reduces the stresses on the hollow shaft or the balancing weight as a result of the effective temperature during the securing operation still further. At the same time, shorter heating times are required, and consequently it is in this case possible for the metal balancing plates to be fixed to the hollow shaft in a very time-saving and consequently also cost-saving way.

It is in this context particularly advantageous for the hollow shaft, at the at least one location, not to exceed a brief maximum temperature of 450° C. during the soldering. The maximum temperature is preferably even lower, for example in a range from 250° C. to 330° C.

It is also proposed that a solder material without flux be used for this purpose. Active solders can preferably be used for a soldering process without flux of this type. For soft soldering, it is preferable to use tin-based or zinc-based solders. By way of example, the following soft solders can be used:
A first soft solder based on tin (Sn) and at least also comprising the constituents silver (Ag) and titanium (Ti), this soft solder preferably being used at a soldering temperature in the range from 240° C. to 260° C.
A second soft solder based on zinc (Zn) and at least also comprising the constituents silver (Ag) and aluminium (Al), this soft solder preferably being used at a soldering temperature in the range from 420° C. to 450° C.

The solders which are expediently selected can be applied, for example, as a powder or a foil. The preferred solution is to use a solder foil (e.g. approx. 0.2 mm thick), which is advantageously provided in series production from a coil of corresponding width. It is also conceivable to process a solder liquid and/or solder balls, solder wire or solder granules.

Fluxes, which have the function of removing the oxide layer from the metallic surface, in many cases include chemical substances which have a harmful influence on health and/or the environment. In this respect, in particular in the context of series production, it is particularly advantageous for the fixing of balancing weights to be carried out by means of solder but without flux. Further advantages which may be mentioned are in particular that, on account of the use of a flux-free solder, it is no longer possible for any corrosion to occur as a result of flux residues, there is no need for flux residues to be cleaned off the components, and the solder is in particular free of heavy metals and can if appropriate be recycled.

In order nevertheless to ensure a high-quality soldered join between metal balancing plate and hollow shaft, it may be advantageous, for example, for the oxide layer to be removed from the location of the hollow shaft at which the metal balancing plate is to be fixed, in a preceding manufacturing step. By way of example, to break open an oxide layer which has formed on that surface of the hollow shaft which is to be soldered, prior to the soldering without the use of flux, it is possible to bring about a relative movement between the solder and the hollow shaft. For this purpose, by way of example, the solder, a balancing weight to which solder has already been applied and/or the hollow shaft can be made to vibrate. Furthermore, it is also possible for the layer of oxide to be mechanically removed or reduced by further means. It is in this context possible, for example, to use grinding tools, in particular belt grinding tools. It is used to abrasively remove the layer of oxide at least from the region of the desired soldering position.

Furthermore, it is also possible, in special applications or on account of the use of special materials for the hollow shaft, for the soldering operation to take place under shielding gas to avoid the formation of further oxide. Since this process variant is expensive and entails considerable technical outlay, it should if possible not be used (in particular as part of series production).

According to an advantageous refinement of the process, the soldering operation at the at least one location lasts no longer than 3 seconds, in particular less than 1.5 seconds or even less than 1 second. It is preferable for the soldering operation to last no longer than 20 seconds or even just 15 seconds in total for all the balancing weights. This allows what is known as in-line production, i.e. the component does not have to be removed from the production flow or balancing process.

It is now also proposed that during the soldering a joining force of less than 2000 N [Newton] and preferably in a range from 50 to 150 N, be exerted on the at least one metal balancing plate towards the hollow shaft. Limiting the joining force in this way on the one hand ensures intimate contact between hollow shaft and solder and between solder and metal balancing plate, so that permanent joins are produced. At the same time, however, it is also ensured that the metal balancing plate and/or the hollow shaft are not deformed. This applies in particular in the case of particularly thin-walled hollow shafts, for example with a wall thickness of less than 2.0 mm.

It is also particularly advantageous for the at least one balancing weight at least to be provided with solder material and then to be fixed to the hollow shaft. This has the advantage, for example, that the solder can easily be positioned on the hollow shaft, namely directly with the balancing weight. It is thereby possible to eliminate simultaneous alignment of the solder material with respect to the hollow shaft and the balancing weight. This leads to an even shorter time being required for fixing the balancing weight to the hollow shaft.

The prior application of solder or prior fixing of the solder to the balancing weight can be carried out, for example, by means of a solder foil by soldering, positive locking or non-positive locking. If a solder liquid is used, this liquid can be applied to the preheated balancing weight, in particular by spraying, at a temperature, for example, of approximately 250°.

When forming the soldered join, it is generally desirable for the solder to be applied as far as possible in punctiform fashion, since during subsequent use of the hollow shaft this leads to the lowest shear stresses. Nevertheless, under certain circumstances it may also be advantageous for solder to be applied to the entire surface, for example to avoid crevice corrosion.

Moreover, this opens up the possibility of varying the balancing weight itself in terms of its mass. For this purpose, it is proposed that a plurality of balancing weights be fixed to the hollow shaft and at least in some cases different quantities of solder material be provided at the balancing weights. This means that in this case the solder material not only performs the function of joining agent between hollow shaft and balancing weight, but also is itself partially acting as a balancing mass. This enables the balancing weights to be produced uniformly within defined tolerance ranges, with the precise balancing mass which is ultimately to be provided being set by the sum of the weight of the balancing weight and the solder material during the joining process. This reduces the outlay on parts with regard to the balancing weight required in series production. However, in particular with regard to costs, it should be ensured that the solder material is preferably selected predominantly as a function of the configuration of the balancing weight. In this context, the quantities of solder material are determined in such a way that the joins of all the balancing weights are able to absorb approximately the same shear forces and centrifugal forces.

According to another configuration of the process, at least one of the following heat sources is used for the soldering: inductor, convector. In this context, the term inductor is to be understood as meaning heat sources which, in accordance with the Joule's resistance heating principle, effect self-heating of the components. Convectors comprise heating surfaces which are heated in a different, non-electrical, way and emit heat. It is preferable to provide a separate heat source for each location on the hollow shaft at which a balancing weight is to be fixed, in order to enable the joining process to be carried out very quickly. However, for certain applications it may also be advantageous for a single heat source to heat at least a plurality of the locations. In this context, it should be pointed out that it is in principle possible for the heat source to be introduced via only one of the sub-components (balancing weights, hollow shaft). In particular, at least one of the following means can be used as heat sources for the soldering process: arc (plasma, TIG, etc.); electrical resistance; soldering iron; friction (high-frequency friction (ultrasonic), face friction); induction; laser beam (diode, Nd-YAG, etc.); gas flame; hot air; infrared light.

According to a further configuration of the process, at least the balancing of the hollow shaft and the soldering of the at least one balancing weight are carried out in one machine. It is preferable for a surface treatment (e.g. for removing an oxide layer from the hollow shaft) also to take place in this machine. It is in this context particularly advantageous if an abrasive belt or the like is at least partially in contact with the surface in the region of the balancing plane during the deceleration of the hollow shaft, which has been set in rotation in order to be balanced. It is then possible to select the required quantity of solder or the appropriate balancing weight, to position it with respect to the hollow shaft and then to solder the two components together. By way of example, less than 15 seconds are required for the operation of applying the balancing weights after the balancing machine has come to a standstill. Then, the hollow shaft can be set in rotation again in order to check that the balancing weights work.

Moreover, the invention proposes a hollow shaft produced by the process described above, which has at least one of the following parameters:
diameter in the range from 40 mm to 100 mm;
wall thickness in the range from 1.0 to 3.0 mm;
length in the range from 300 to 2000 mm.

With the form of production proposed here, the wall thicknesses may under certain circumstances, on account of the reduced effective heat, be reduced to 1.0 mm to 2.0 mm, while the performance of the hollow shaft remains the same.

The hollow shafts described here are used, for example, for torque transmission and are accordingly operated, for example, at rotational speeds of up to 8000 ¹/min or even 12000 ¹/min [revolutions per minute] while they are in use. In this case, torques in the range up to 5000 (static) Nm [Newton metres] are transmitted. Hollow shafts of this type are used in particular as propshafts of vehicles with rear wheel drive (such as for example limousines, small transporters, vans). Hollow shafts of this type are also used, for example, in wind power plants, machine tools or other drive trains. Hollow shafts produced in this manner usually rotate at a rotational speed of at least 3000 ¹/min in use. With these highly stressed, thin-walled hollow shafts, it is especially important to ensure permanent fixing of the balancing weights, since detachment of the weights in use leads to the balancing weights being thrown into the surrounding area at a very high speed, which could cause them to hit components and/or people. This is avoided by the way of producing the soldered join described above.

According to one configuration of the hollow shaft, the hollow shaft comprises a steel material which has a mean tensile strength in the range up to 1000 N/mm². If the hollow shaft comprises a light metal material, for example in the case of an aluminium hollow shaft it preferably has a mean tensile strength in the range from 290 to 700 N/mm², and in the case of a titanium hollow shaft it has a mean tensile strength of preferably up to 1700 N/mm². The mean tensile strengths and hardnesses given here from various configurations of the hollow shafts allow torque transmission, in particular within the range mentioned above, for a particularly long period of use. At the same time, the hollow shafts are designed in such a way that they are able to withstand high dynamic load changes. Accordingly, the elongate, thin-walled components satisfy high demands, in particular because there is no weakening of subregions of the hollow shaft during fixing of the balancing weights, which are responsible for low-oscillation rotary operation.

Furthermore, it is also proposed that the at least one balancing weight at least has a density of 7.0 g/cm³ [grams per cubic centimetre]. It is preferable for the balancing weights used to be metal balancing plates made from steel or copper. The relatively high density has the advantage that only a small number of balancing weights or only relatively small balancing weights have to be fixed to the hollow shaft. Such small balancing weights are also more dimensionally stable and are easier to join in punctiform fashion. This saves both materials costs and joining times. In particular, at least one of the following materials is preferred for the balancing weight: iron (7.3 g/cm³), copper (8.9 g/cm³), zinc (7.1 g/cm³) or tungsten (19.25 g/cm³).

According to another configuration of the hollow shaft, the at least one balancing weight has a height which does not exceed 3 mm [millimetres]. It is preferable for all the balancing weights to be of the same height. This, combined with a correspondingly adapted solder surface area, means that approximately identical gravity forces act on the solder material, and therefore a similar safety standard can be ensured for all balancing weights.

In particular with the invention described here, but fundamentally also independently of it, a hollow shaft comprising a metallic material and at least one balancing weight is proposed; a join which can be released again nondestructively is provided with regard to the hollow shaft and the at least one balancing weight. This join is in particular a soldered join. The join which can be released again nondestructively can preferably be released again under the action of heat, in particular in a temperature range from 200° C. to 400° C. In this context, the term “nondestructively” means in particular that no mechanical effect which is significant (for the demands of the hollow shaft) on the surface of the hollow shaft is observed, and there is preferably also no significant change in the material microstructure of the hollow shaft. This makes hollow shafts of this type possible to repair and recycle.

Moreover, it is also proposed that the soldered join between the hollow shaft and the at least one balancing weight has a soldered tensile strength in the range from 100 to 140 N/mm² [Newton per square millimetre]. This value can be determined using a standard tensile test, which is to be carried out at room temperature in the way which will be familiar to the person skilled in the art. This soldered tensile strength ensures long-term use at high rotational speeds and, for example, torque transmission in the range up to 5000 N/m.

It is advantageous for at least one hollow shaft of this type to be used in a drive system for a vehicle. The vehicle having a drive system of this type can be exposed, for example, to even particularly extreme driving cycles off road without the risk of the balancing weight becoming detached from the hollow shaft. The lower thermal stressing of the hollow shaft during fixing of the metal balancing plates ultimately leads to a significantly increased service life. At the same time, a time-saving and cost-saving method of producing the vehicles is now also made possible.

The invention and the technical background are explained in more detail below with reference to the figures. In this context, it should be noted that the figures show particularly preferred exemplary embodiments, without the invention being restricted to these embodiments. In the drawing:

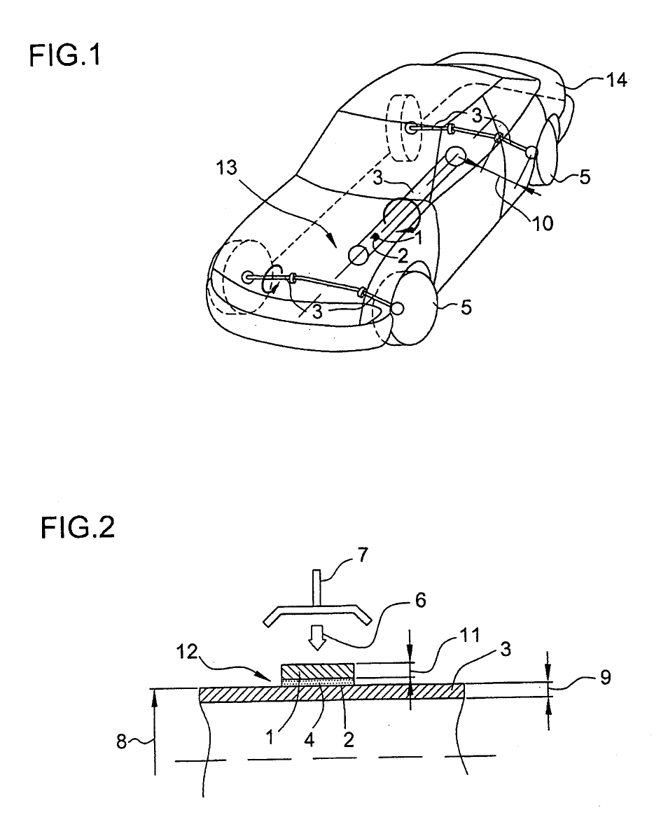

FIG. 1 shows a diagrammatic and perspective view of a vehicle with a drive system comprising a hollow shaft with balancing weights, and

FIG. 2 shows a section through a detail of a hollow shaft with balancing weight.

FIG. 1 shows a diagrammatic and perspective view of a vehicle 14, the drive system 13 of which includes a plurality of hollow shafts 3. These are used in particular to transmit torque from the engine to the rear wheels 5. The location 2 at which a balancing weight 1 is positioned is marked on a hollow shaft 3. This centrally arranged hollow shaft 3 in the middle of the vehicle 14 transmits the torque to the rear axle and is generally referred to as the propshaft. Propshafts of this type may be of single-part or multi-part construction. The dimensions depend on the space conditions in the particular vehicle. This propshaft usually has a length 10 in the range from 300 to 2000 mm. Although at present it is virtually exclusively propshafts which are balanced, while the sideshafts are generally provided with separate damping which compensate for any unbalance which may occur, it is equally possible for these sideshafts to be balanced, for example to replace the damping system. This fundamental idea may if appropriate also be implemented independently of the soldered joining of the balancing weights described here.

FIG. 2 shows a diagrammatic illustration, in cross section through the hollow shaft 3, of a soldered join 12. The hollow shaft 3 has a diameter 8 in the range from 40 to 100 mm, with a wall thickness 9 in the range from 1.5 to 3 mm. A balancing weight 1 has now been fixed to the surface of the hollow shaft 3, secured to the hollow shaft 3 by means of a solder material 4. The balancing weight 1 consists of a steel material with a height of approximately 3 mm. This soldered join 12 is produced by the balancing weight 1 being oriented with respect to the hollow shaft 3 and pressed onto the surface of the hollow shaft 3 with a joining force 6, the heat required to melt the solder material 4 being generated by means of the heat source 7. The temperature generated is above the melting range of the solder material 4; the melting range is to be understood as meaning the temperature range at which suitable wetting of the solder with respect to the joining components is achieved. The fixing of the balancing weight 1 is effected by means of soft soldering.

In particular in the context of series production, the invention allows reliable and rapid fixing of the balancing weights 1 to a hollow shaft 3. At the same time, it is ensured that the balancing weight 1 is able to withstand the corresponding loads. The material of the hollow shaft 3 is not adversely affected during the joining process, with the result that particularly thin-walled and therefore also lightweight hollow shafts 3 can be integrated in drive systems 13 of vehicles 14.

### LIST OF DESIGNATIONS

1 Balancing weight
2 Location
3 Hollow shaft
4 Solder material
5 Wheel
6 Joining force
7 Heat source
8 Diameter
9 Wall thickness
10 Length
11 Height
12 Soldered join
13 Drive system
14 Vehicle

1. A process for fixing at least one balancing weight to at least one location on a hollow shaft, for torque transmission at rotational speeds in the range of 3000 rpm to 12000 rpm in a drive system for a vehicle, comprising securing the at least one balancing weight to the at least one location by moans of soldering or brazing.

2.-18. (canceled)
